(19) United States
(12) Patent Application Publication
(10) Pub. No.: US 2018/0322222 A1
(43) Pub. Date: Nov. 8, 2018

(54) SYSTEMS AND METHODS FOR UPDATING PMI FOR CAD MODELS

(71) Applicant: General Electric Company, Schenectady, NY (US)

(72) Inventors: Alexandria Stoker Cochrane, Greenville, SC (US); Hoil Song, Greenville, SC (US); Mohamed Karim Baig, Bangalore (IN); Jason Anton Byers, Greenville, SC (US); James Philip Stanley, SR., Liberty, SC (US)

(21) Appl. No.: 15/589,635

(22) Filed: May 8, 2017

(51) Int. Cl. G06F 17/50

(52) U.S. Cl. CPC G06F 17/50; G06F 2217/12

(57) ABSTRACT

A tangible, non-transitory, computer-readable medium, including computer-readable instructions that, when executed by one or more processors of a computer, cause the one or more processors to generate a first digital product definition associated with a computer-aided design (CAD) model. Furthermore, the computer-readable instructions cause the one or more processors to present, via a graphical-user-interface (GUI) on a display, the first digital product definition, such that the first digital product definition includes product and manufacturing information (PMI) associated with the CAD model, generate a second digital product definition based on a selection via the GUI, such that the second digital product definition includes a portion of the PMI associated with the CAD model that is indicated by the selection, receive an indication to modify at least a subset of the portion of the PMI of the second digital product definition, modify the at least subset of the portion of the PMI of the second digital product definition based on the indication, and update the PMI of the first digital product definition, based on the modification to the subset of the portion of the PMI.

### BACKGROUND

The subject matter disclosed herein relates to systems and methods for modifying objects, such as product manufacturing information (PMI) (e.g., on rendered 3D models that may contain annotations) for industrial machine parts depicted in design applications.

Industrial machines and machine parts may be designed for a particular purpose, such as a compressor blade designed to compress air. The design and quality inspection of the machine or part may include calibration between various plant operators (e.g., inspectors, designers, etc.). It may be beneficial to improve the methods and systems these plant operators use to design, inspect, and/or modify the machine parts.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosed subject matter may encompass a variety of forms that may be similar to or different from the embodiments set forth below.

In a first embodiment, a tangible, non-transitory, computer-readable medium, including computer-readable instructions that, when executed by one or more processors of a computer, cause the one or more processors to generate a first digital product definition associated with a computer-aided design (CAD) model. Furthermore, the computer-readable instructions cause the one or more processors to present, via a graphical-user-interface (GUI) on a display, the first digital product definition, such that the first digital product definition includes product and manufacturing information (PMI) associated with the CAD model, generate a second digital product definition based on a selection via the GUI, such that the second digital product definition includes a portion of the PMI associated with the CAD model that is indicated by the selection, receive an indication to modify at least a subset of the portion of the PMI of the second digital product definition, modify the at least subset of the portion of the PMI of the second digital product definition based on the indication, and update the PMI of the first digital product definition, based on the modification to the subset of the portion of the PMI.

In a second embodiment, a system includes a processor for implementing a computer-aided technology (CAx) system, the CAx system including a graphical-user-interface (GUI) that presents a computer-aided design (CAD) model, the CAD model including at least one part and memory storing instructions that cause the processor to present the GUI, generate a first digital product definition associated with the CAD model, and present, via the GUI on a display, the first digital product definition, such that the first digital product definition includes product and manufacturing information (PMI) associated with the CAD model. Furthermore, the memory storing instruction cause the processor to generate a second digital product definition based on a selection via the GUI, such that the second digital product definition includes a portion of the PMI associated with the CAD model that is indicated by the selection, receive, via the GUI, an indication to modify at least a subset of the portion of the PMI of the second digital product definition, modify the at least subset of the portion of the PMI of the second digital product definition based on the indication, and update the PMI of the first digital product definition, based on the modification to the subset of the portion of the PMI.

In a third embodiment, a computer-implemented method includes generating, via a processor, a first digital product definition associated with a computer-aided design (CAD) model, presenting, via a graphical-user-interface (GUI) on a display, the first digital product definition, such that the first digital product definition includes product and manufacturing information (PMI) associated with the CAD model, generating, via the processor, a second digital product definition based on a selection via the GUI, such that the second digital product definition includes a portion of the PMI associated with the CAD model that is indicated by the selection, receiving, via the processor, an indication to modify at least a subset of the portion of the PMI of the second digital product definition, modifying, via the processor, the at least subset of the portion of the PMI of the second digital product definition based on the indication, and updating, via the processor, the PMI of the first digital product definition, based on the modification to the subset of the portion of the PMI.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an embodiment of a block diagram of an embodiment of a computer-aided technology (CAx) system, in accordance with an aspect of the present disclosure;

FIG. 2 is an embodiment of a block diagram of a certain components of the CAx system of FIG. 1, in accordance with an aspect of the present disclosure;

FIG. 3 is an embodiment of a block diagram of an industrial system that may be conceived, designed, engineered, manufactured, and/or service and tracked by the CAx system of FIG. 1, in accordance with an aspect of the present disclosure;

FIG. 4 is an embodiment of a schematic of a product quality plan (PQP) tool that may be used to make modifications to a component of the industrial system of FIG. 3, in accordance with an aspect of the present disclosure;

FIG. 5 is a flow diagram illustrating a process whereby an intermediate model may be generated from a full model, in accordance with an aspect of the present disclosure;

FIG. 6 is an embodiment of a digital product definition that includes a full model and associated product and manufacturing information (PMI), in accordance with an aspect of the present disclosure;

FIG. 7 is an embodiment of a dialogue box of the CAx system of FIG. 1 that is used to generate intermediate models from the full model of FIG. 6, in accordance with an aspect of the present disclosure;

FIG. 8 is an embodiment of an intermediate model generated from the full model of FIG. 6 using the dialogue box of FIG. 7, in accordance with an aspect of the present disclosure; and

FIG. 9 is a flow diagram illustrating a process whereby the full model of FIG. 6 is updated based on the updates made to the intermediate model of FIG. 8, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a part design. For example, the part design may be created as a model-based definition included in a 2-dimensional (2D) or 3-dimensional (3D) computer aided design (CAD) model. After creating the CAD part, a depiction of the CAD part, hereinafter referred to as “a digital product definition,” may be generated by a computer-aided technology (CAx) system, whereby the digital product definition may be used to help facilitate manufacture the part. In certain embodiments, the digital product definition may include a 2-dimensional (2D) and/or 3D depiction (e.g., model) of the part.

Furthermore, the digital product definition may include objects such as, product and manufacturing information (PMI) (e.g., callouts, text, etc.), that may be displayed on the model, in some instances. It should be noted that while “PMI,” used hereinafter to refer to objects displayed on 3D models such as, digital product definitions, the systems and methods described above and below are applicable to any objects displayed on the model such as graphics (e.g., arrows, shapes, etc.), tables (e.g., bill of materials, etc.), and the like. The PMI may include information indicative of the features, tolerances, and/or other suitable information that may aid in the manufacturing and design of the part. For example, a digital product definition for a model may include PMI indicating (e.g., via text on the digital product definition) the dimensions (e.g., hole diameter, clearances, etc.) of a tube.

Furthermore, teams 64 of plant operators may edit a subset of the PMI on the models of the design parts to enhance the accuracy of the PMI of the part. Meanwhile, other teams 64 may edit a different subset of PMI. For example, a first team of plant operators may edit the data indicative of tolerances for a tube, while a second team of plant operators may edit the data indicative of the materials of a tube. In some embodiments, the models may include a variety of PMI, such that some of the variety of PMI may not be relevant to a team 64 of plant operators. For example, the first set of plant operators may not want to have to search through all the PMI (e.g., indicative of the material, fittings, casting, material, etc. of a tube) on a digital product definition before finding and editing the tolerances of the tube. As such, it may be beneficial to have a system and methods for creating intermediate models of the model (e.g., full model) that may include a subset of the data of the full model, such that the subset of data may be relevant to the respective teams 64 of plant operators. It may further enhance the efficiency of the design and quality control process if updates (e.g., modifications) made to the intermediate models were also applied to the full model.

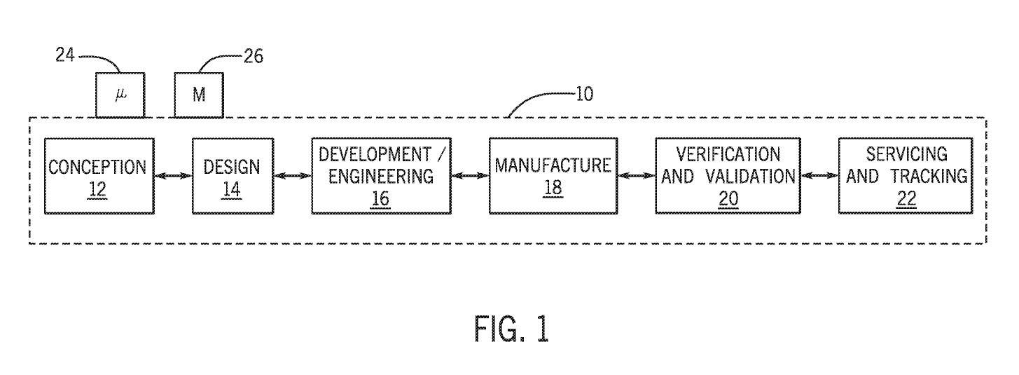

With the foregoing in mind, it may be useful to describe a computer-aided technologies (CAx) system that may incorporate the techniques described herein, for example to improve the generation of PMI objects on part drawings. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machine). A series of design processes 14 may then use the specifications and/or prototype to produce, for example, one or more 3D design models of the part or product. The 3D design models may include solid/surface modeling, parametric models, wireframe models, vector models, non-uniform rational basis spline (NURBS) models, geometric models, 2D manufacturing part and assembly drawings, and the like.

Design models may then be further refined and added to via the execution of development/engineering processes 16. The development/engineering processes may, for example, create and apply models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in tolerances, materials specifications (e.g., material type, material hardness), clearance specifications, and the like.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. After the part is inspected, results from the CMM process may be automatically generated via an electronic Characteristic Accountability & Verification (eCAV) system.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be used by any other of the processes 12, 14, 16, 18, 20, 22 to improve the part or product or to create anew part or anew product. In this manner, the CAx system 10 may incorporate data from downstream processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

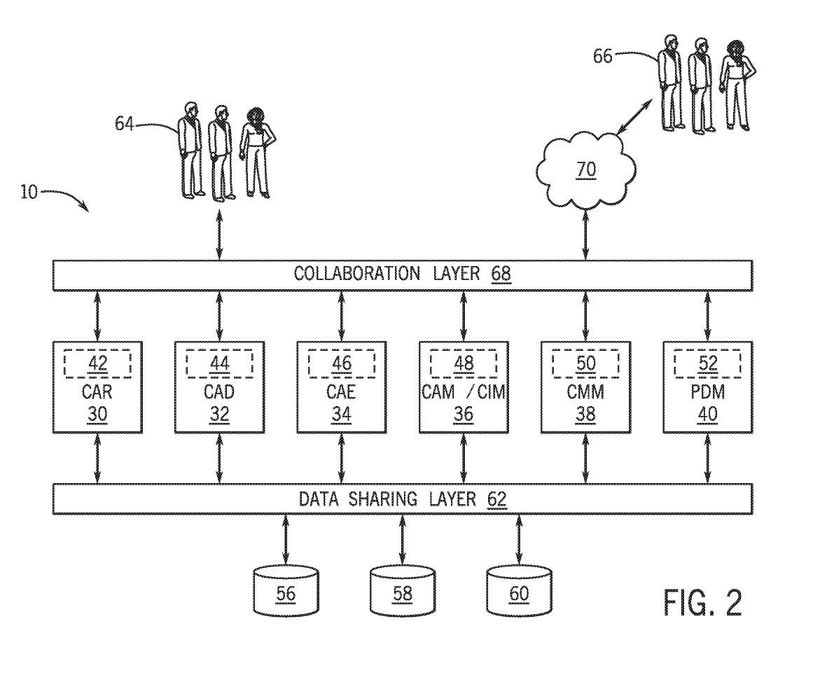

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40. Each of the systems 30, 32, 34, 36, 38 and 40 may be extensible and/or customizable, accordingly, each system 30 may include an extensibility and customization system 42, 44, 46, 48, 50, and 52, respectively. Additionally, each of the systems 30, 32, 34, 36, 38 and 40 may be stored in a memory system, such as memory system 26, and may be executable via a processor, such as via processors 24.

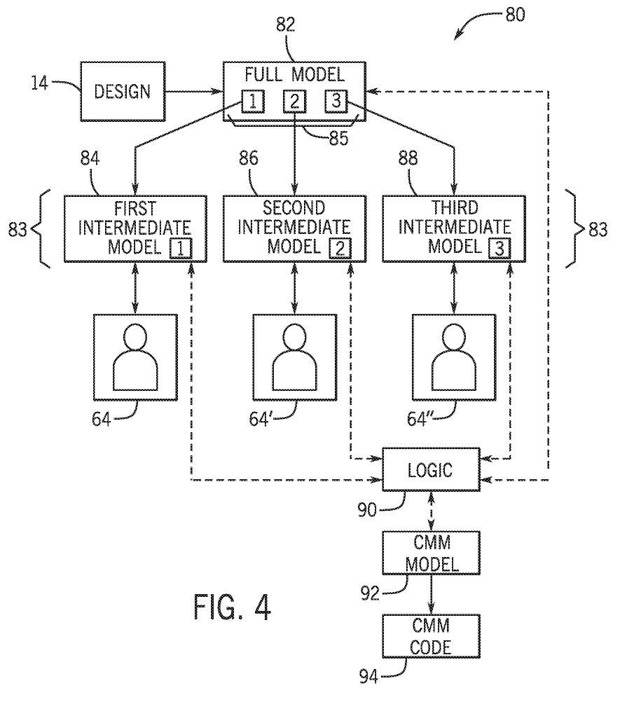

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, PMI object, etc.). Indeed, the CAD system 32 may combine a graphical representation of the part or product with other, related information. Further, the CAD system 32 may adjust the PMI object displayed on various drawings displaying multiple views and/or orientations of the same part, as discussed in detail in FIG. 4.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics (MBD) and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, and/or 38. For example, the systems 30, 32, 34, 36, and/or 38 may communicate with data repositories 56, 58, 60 via a data sharing layer 62. The PDM system 40 may then manage collaboration between the systems 30, 32, 34, 36, and/or 38 by providing for data translation services, versioning support, archive management, notices of updates, and so on. The PDM system 40 may additionally provide for business support such as interfacing with supplier/vendor systems and/or logistics systems for purchasing, invoicing, order tracking, and so on. The PDM system 40 may also interface with service/logging systems (e.g., service center data management systems) to aid in tracking the maintenance and life cycle of the part or product as it undergoes operations. Teams 64, 66 may collaborate with team members via a collaboration layer 68. The collaboration layer may include web interfaces, messaging systems, file drop/pickup systems, and the like, suitable for sharing information and a variety of data. The collaboration layer 68 may also include cloud-based systems 70 or communicate with the cloud-based systems 70 that may provide for decentralized computing services and file storage. For example, portions (or all) of the systems 30, 32, 34, 36, 38 may be stored in the cloud 70 and/or accessible via the cloud 70.

The extensibility and customization systems 42, 44, 46, 48, 50, and 52 may provide for functionality not found natively in the CAR system 30, the CAD system 32, the CAM/CIM system 36, the CMM system 38 and/or the PDM system 40. For example, computer code or instructions may be added to the systems 30, 32, 34, 36, and/or 38 via shared libraries, modules, software subsystems and the like, included in the extensibility and customization systems 42, 44, 46, 48, 50, and/or 52. The extensibility and customization systems 42, 44, 46, 48, 50, and 52 may also use application programming interfaces (APIs) included in their respective systems 30, 32, 34, 36, and 38 to execute certain functions, objects, shared data, software systems, and so on, useful in extending the capabilities of the CAR system 30, the CAD system 32, the CAM/CIM system 36, the CMM system 38 and/or the PDM system 40. By enabling the processes 12, 14, 16, 18, 20, and 22, for example, via the systems 30, 32, 34, 36, and 38 and their respective extensibility and customization systems 42, 44, 46, 48, 50, and 52, the techniques described herein may provide for a more efficient “cradle-to-grave” product lifecycle management.

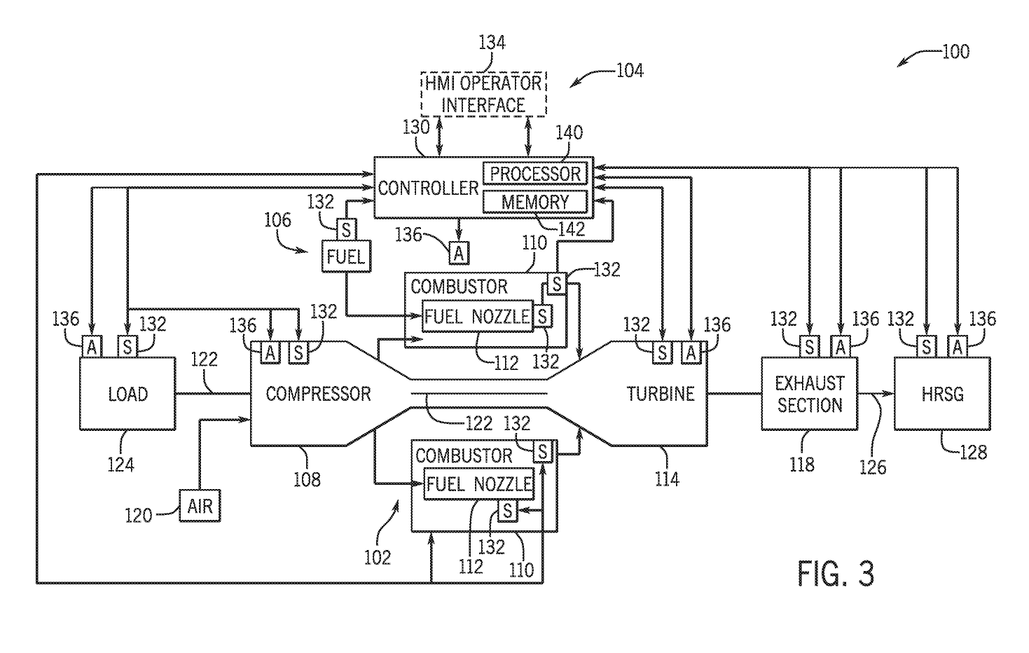

It may be beneficial to describe a machine that may incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 1, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades, which may in turn drive rotation of a shaft 122. The shaft 122 may connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power production system 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the power production system 100 may also include a controller 130. The controller 130 may be communicatively coupled to a number of sensors 132, a human machine interface (HMI) operator interface 134, and one or more actuators 136 suitable for controlling components of the power production system 100. The actuators 136 may include valves, switches, positioners, pumps, and the like, suitable for controlling the various components of the power production system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the power production system 100. A team 64 of plant operator may interface with the industrial system 10 via the HMI operator interface 44. Accordingly, the HMI operator interface 134 may include various input and output devices (e.g., mouse, keyboard, monitor, touch screen, or other suitable input and/or output device) such that the team 64 of plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

Designing, modifying, and manufacturing components of the aforementioned parts associated with power generation systems (e.g., and/or any other system) may require a variety of collaboration between various teams of plant operators. In some embodiments, it may be beneficial to generate specialized models associated with the parts of power generation systems to edit or modify PMI (e.g., or other information associated with the specialized model and/or part). As such, a product quality plan (PQP) tool may help facilitate the design, modification, and manufacturing of the parts by providing a platform that allows the teams of plant operators to simultaneously update (e.g., modify) the specialized models associated with the parts of the power generation system. Furthermore, the PQP tool may allow for the collaboration of team members by allowing the updates to certain specialized models to be applied to other specialized models.

With the forgoing in mind, FIG. 4 is a general schematic of an embodiment of a layout for a product quality plan (PQP) tool 80. As illustrated, a series of design processes 14 may be used to create a full model 82 that includes a full set (e.g., variety) of PMI 85 associated with a part and/or assembly produced by the CAD system 32. The design processes 14 may result in the production of, for example, one or more digital product definitions (e.g., drawing, display rendering, etc.) illustrating the full model 82 (e.g., or part) and the full set of PMI 85. “Digital product definition,” as used herein, may refer to a rendering of a part (e.g., a tube for a component of the power production system 100), such that the rendering may include a full set of PMI 85 (e.g., that may include a first set of PMI (block 1), a second set of PMI (block 2), and a third set of PMI (block 3)) associated with the rendered part. For example, a full model 82 may include rendering of a tube. The tube may be associated with PMI indicative of the material properties, the dimensions of features of the tube, the tolerances of the tube, the steps for manufacturing the tube, and/or other suitable PMI.

Logic 90 may receive data indicative of the full model 82. In some embodiments, the logic 90 may be computer-readable instructions stored in memory 26. The computer-readable instructions may cause the processor 24 to execute a series of instructions. The instructions may include instructions for capturing a subset of PMI 85 (e.g., the first set of PMI (block 1), the second set of PMI (block 2), and/or the third set of PMI (block 3)). For example, the instructions may include receiving data indicative of the full model 82. As described in more detail below, the logic 90 may receive an indication to generate an intermediate model(s) 83. In some embodiments, the intermediate model 83 may display a portion or the full part, but only include a subset of the full set of PMI 85. That is, the intermediate model(s) 83 may include a subset (e.g., the first set of PMI (block 1), the second set of PMI (block 2), and/or the third set of PMI (block 3)) of the data (e.g., PMI) associated with the full model 82.

After receiving a request to generate intermediate model(s), the logic 90 may generate a first intermediate model 84, a second intermediate model 86, a third intermediate model 88, and/or any number of requested intermediate models. For example, the first intermediate model 86 may include a subset of data from the full model 82, such as, for example, PMI indicative of the tolerances for screw holes of the tube. The second intermediate model 86 may include another subset of data from the model 82, such as, for example, PMI indicative of the dimensions of an opening of the tube. The third intermediate model 88 may include a third subset of data from the model 82, such as, for example, PMI indicative of the material properties of the tube. Three intermediate models 83 may be beneficial to teams 64, 64′, and/or 64,″ for example, when the three teams are tasked with different tasks that may use only a subset of the full set of PMI 85.

For example, team 64 may be tasked with modifying tolerances of the part and use the first intermediate model 84 to aid in the tolerancing of the part, such that the first intermediate model 84 may include a subset of the PMI 85 associated with tolerances for the dimensions of the part. Furthermore, team 64′ may be tasked with lathing a pipe to a given dimensions and use the second intermediate model 86 to aid in the lathing of the part, such that the second intermediate model 86 includes a subset of the PMI 85 associated with lathing. Further, team 64″ may be tasked with welding components of the part and use the third intermediate model 88 to aid in the welding of the part, such that the third intermediate model 88 includes a subset of the PMI 85 associated with welding callouts for the part.

In some embodiments, the intermediate models 83 may not have any PMI in common with the other intermediate models 83. For example, the first intermediate model 84 may include a first subset of the data from the full model 82, such that the first subset of data does not include PMI found in the second intermediate model 86 nor the third intermediate model 88.

In other embodiments, the intermediate model 83 may have data in common with other intermediate models 83. For example, the first intermediate model 84 may include information indicative of PMI for the measurements of the tube of the full model 82. The second intermediate model 86 may include the PMI for an opening of the tube (e.g., including its measurements). As such, the first and second intermediate model (84, 86) may share PMI (e.g., have an overlap in PMI data) indicative of the measurements of the opening of the tube.

It should be noted, the logic 90 may allow for the exchange of data among the various components in the illustrated embodiment. For example, the logic 90 may allow for the exchange of data between the intermediate models 83, the full model 82, and the CMM model 92. Furthermore, in the illustrated embodiment, teams of plant operators (e.g., teams 64, teams 64′, and/or teams 64″ may respectively update (e.g., modify) the first intermediate model 84, the second intermediate model 86, and the third intermediate model 88. The logic 90 may receive indications of the updates to the intermediate models 83 and apply the updates (e.g., in real-time or near real-time) to the full model 82. That is, when team 64 of plant operators update the PMI of the first intermediate model 84, the corresponding PMI on the full model 82 may also be updated.

For example, the tolerance for a dimension of a tube (e.g., or any other PMI) may be updated on the first intermediate model 84. As such, in some embodiments, the full model 82 may be updated (e.g., by logic 90) to reflect the updates to the first intermediate model 84. Furthermore, in some embodiments, when another intermediate model 83, such as the second intermediate model 86, shares the subset of data (e.g., PMI) updated on the first intermediated model 84, the second intermediate model 86 may be updated to reflect the modification made to the first intermediate model.

Furthermore, after generating an updated final version of the full model 82, based at least on the updates made to the intermediate models 83, the logic 90 may generate a coordinate measurement machine (CMM) model 92. The CMM model 92 may define PMI by their inspection path. For example, for CMM model may group PMI based on the order (e.g., inspection path) the PMI will be needed when the part displayed in the CMM model 92 (e.g., or full model 82) undergoes the verification and validation process 20 (e.g., or any other suitable process). In some embodiments, the CMM model 92 may also include naming for the PMI that aids in associating PMI, such as tolerances with their feature and/or inspection paths.

The logic 90 may further generate CMM code 94 that may prepare the data indicative of the full model 82 and/or CMM model 92 to be converted to a specific format of CMM code 94. For example, the generating of CMM code 94 may facilitate the conversion of the code from a first format (e.g., T.S., NX format, etc.) to any suitable CMM format. In some instances, converting CMM code 94 from the format generated by the CMM model 92 to a format readable by CMM machines, depending on the language a given machine reads, may require manual alterations that may be time-consuming and have high quality risks. Using the disclosed approach, the logic 90 takes preliminary steps possible in the CMM model 92 to organize data by a recognizable naming convention that links together aspects of the CMM code 94 (e.g., inspection paths, tolerances, and features). For example, the logic 90 may group and/or order the inspection paths, features, and/or tolerances so that they are seen together. In some embodiments, the logic 90 may also print out header information that the teams of plant operators would otherwise type manually, assign general tolerancing for measurements that would otherwise be displayed as “untoleranced” and therefore, edited manually, and handle a series of specific issues presented by the modeling platform that would otherwise be tweaked manually until functioning.

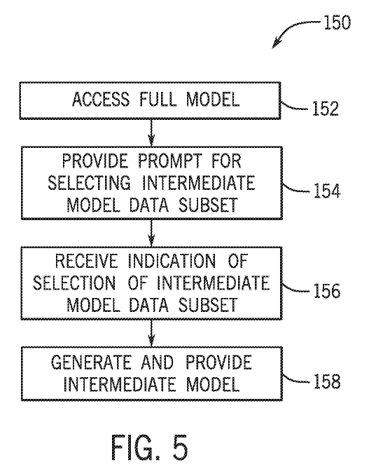

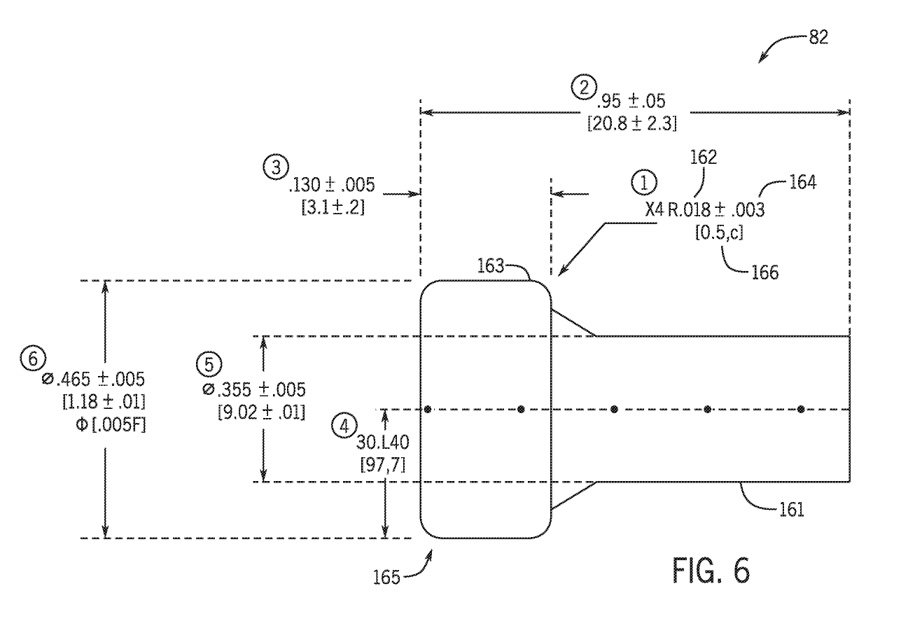

With the aforementioned subject matter in mind, FIG. 5 is a flow diagram illustrating a process 150 whereby an intermediate model 83 may be generated from a full model 82. The logic 90 may receive data indicative of the full model 82, which in some embodiments, may allow the logic 90 to access the full model 82. In more detail, the logic 90 may access the full model 82 (process block 152) (e.g., a model that may include a component of the power production system 100 and a full set of PMI 85 associated with the component). In some embodiments, the logic 90 may automatically gain access to the full model 82 when a full model 82 is created. In other embodiments, the logic 90 may receive an indication (e.g., from a plant operator) to receive a full model 82. As such, in some embodiments, the logic may gain access to a full model 82 when a plant operator specifies a full model 82 on a GUI. An example of a full model 82 and PMI associated with it are illustrated in FIG. 6 and discussed in detail below with regards to FIG. 6.

After receiving access to the full model 82, the logic 90 may provide a prompt (e.g., user-prompt on a guided user interface (GUI) of the CAD system 32) for selecting the intermediate model data subset. The team 64 of plant operators may select an intermediate model data subset. For example, the teams 64 (e.g., or any other operators) may select a relevant subset of intermediate model data based upon subsequent tasks to be performed using the intermediate model 83. The logic 90 may receive an indication of the intermediate model data subset to generate and provide an intermediate model that includes the selected intermediate model data subset.

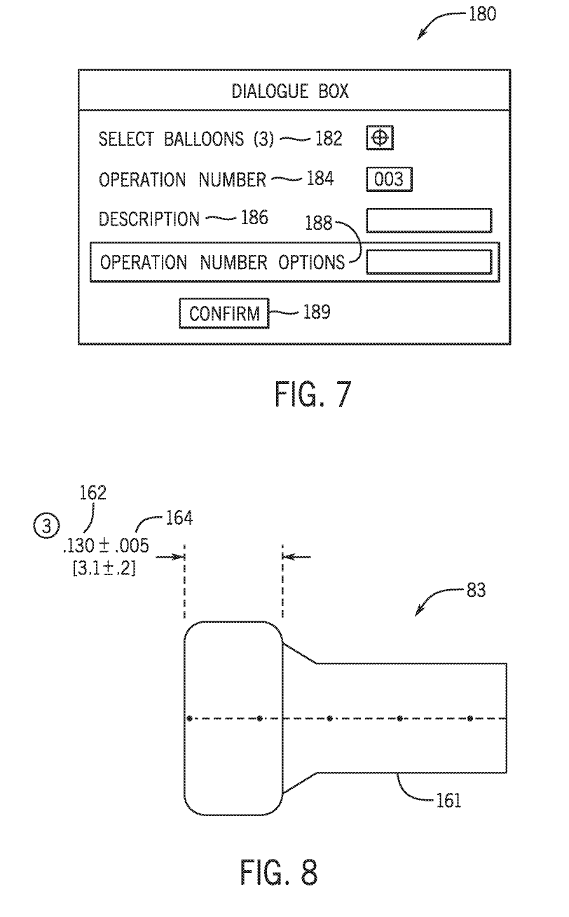

After gaining access to the full model 82, the logic 90 may provide a prompt (e.g., on the GUI) for selecting an intermediate model data subset (process block 154). In some embodiments, the prompt may be displayed on a computing device (e.g., computer, tablet, mobile device, laptop, etc.). In certain embodiments, the prompt may include options for selecting and generating intermediate models 83 that include a preset data subset from the full model 82. An example of an embodiment of a prompt for selecting intermediate model data subset is discussed in detail below with regards to FIG. 7.

Furthermore, the logic may receive an indication of the selection for an intermediate model data subset (process block 156). In some embodiments, the indication of the selection may include a team 64 of plant operators selecting a subset of data from a drop-down menu on the GUI of the CAD system 32, for example, by hover an arrow on the user interface over a button reading “make selection.” In more detail, the drop down menu may include eight pre-set data subset options, such that selecting one of the subsets may send a signal indicative of a selection the intermediate data subset.

In some embodiments, selecting more than one of the pre-set data subset option may send a signal indicative of selecting an intermediate model data subset (process block 156) that includes PMI (e.g., or any relevant data) associated with the more than one pre-set data subset options that are selected. Furthermore, the indication of a selection of the intermediate data subset may include a confirmation prompt after specifying the selection of the intermediate model data subset, such that a user may confirm (e.g., click) the selection via the user interface, finalizing the selection of the data for the intermediate model.

As such, after the indication of a selection of the intermediate model data subset is made, the logic 90 may generate and provide an intermediate model (process block 158). The intermediate model may include the intermediate model data subset selected (e.g., on the GUI by a plant operator). In some embodiments, more than one intermediate models may be generated, based at least in part on the indication(s) received by the logic 90. An example of an embodiment of an intermediate model generated is discussed in detail below regarding the discussion of FIG. 8.

Turning now to FIG. 6, an embodiment of a digital product definition that includes a full model 82 and associated PMI objects that may be generated by the CAD system 32 is provided. Used herein, “PMI objects” may refer to any annotation, callout, note, or the like, indicative of PMI for the object and/or assembly illustrated in the digital product definition. As illustrated, the digital product definition of the full model 82 displays a side view a tube 161. Furthermore, the full model 82 includes PMI relevant to the tube 161. That is, the illustrated embodiment includes six PMI objects, indicated by balloons numbered “1” through “6” inside the balloons.

For example, a first PMI object (e.g., indicated by a number one (“1”) inside a circle) includes dimensions 162 of the chamfered edge 163 of the tube 161. The dimensions 162 may also include tolerances 164 that may indicate the feature (e.g., chamfered edge 163) may meet dimension requirements if the dimensions (e.g., radius indicated by “R”) are within the specified tolerances 164 with respect to the dimensions 162. That is, as long as the part (e.g., tube 161) is manufactured to have chamfered edges 163 between 0.015 and 0.021, the dimension of the feature of the part may satisfy manufacturing requirements. Furthermore, in some embodiments the number in front of the dimension 162 may indicate the number of times the dimension 162 may be indicated on the digital product definition. The “x4” in front of the dimension 162 may indicate that the dimension 162 and tolerances 164 are indicated four times in the full model 82. In some instances, additional information 166 may be displayed and included as part of the first PMI object. In the current embodiment, [0.5,c] may indicate PMI relevant to teams 64, 64′ or 64″ of plant operators. For example, the “0.5” may indicate the size of a weld bead, while the “c” may designate the welding finishing symbol. Furthermore, in some embodiments, PMI between brackets (e.g., [ ]) may be designated to reference PMI associated with certain units (e.g., metric, standard, etc.), welding callouts, and the like

Furthermore, in the illustrated embodiment, the second PMI object (e.g., designated with a balloon numbered “2”) includes dimension and tolerances associated with the length of the pipe. The second PMI object may include any other PMI indicative of the pipe. Further, the third PMI object (e.g., designated with a balloon numbered “3”) includes dimensions and tolerances associated with the length of the outer head 165 of the tube 161. Further, a fourth PMI object (e.g., designated with a balloon numbered “4”) may include PMI indicative of one or more characteristics of the feature it references. In the illustrated embodiment, the fourth PMI object may include dimensions indicative of the radius of the outer head 165 of the tube 161. Further, the fifth PMI object (e.g., designated with a balloon numbered “5”) includes dimensions and tolerances associated with the diameter (e.g., designated with symbol “o”) of the shaft of the tube 161. Furthermore, the sixth PMI object (e.g., designated with a balloon numbered “6”) includes dimensions and tolerances associated with the outer diameter (e.g., designated with symbol “o”) of the outer diameter of the outer head 165 of the tube 161. Although the illustrated embodiment mainly includes PMI objects indicative of dimensions for the features of tube 161, it should be noted that in some embodiments the full model 82 may include any geometric dimensioning and tolerancing (GD&T) information relevant to the full model 82.

Turning now to a discussion regarding selection of the intermediate model data subsets, FIG. 7 is an embodiment a dialogue box 180 of the user interface of the CAx system 10 that is used to generate intermediate models from a full model. In some embodiments, the dialogue box 180 may allow a user to manually create an intermediate model by specifying the PMI included in the full model 82 that the user may want to be included in the intermediate model (e.g., an intermediate model may include the third PMI (designated as balloon 3) and the illustration of the tube 161 of FIG. 3, as illustrated in FIG. 7).

In more detail, the dialogue box 180 may include a first prompt 182 for selecting balloons. As mentioned above, the PMI objects on the full models displayed on the digital product definition may be designated with balloons. For example, a first PMI object may include a balloon with the number one inside of the balloon, a second PMI object may include a balloon with the number two inside of the balloon, etc. In some embodiments, to propagate the balloon selection of the first prompt 182, a user may select (e.g., by hovering over a balloon with an arrow and clicking a mouse) a balloon on full model of a part. The PMI associated with the selected balloon may be included in the intermediate model after approving of the selections displayed on the first prompt 182. Furthermore, as balloons are selected, an indication of a number of selected balloons and/or the particular selected balloons may be provided in the dialogue box 180 (e.g., balloon 3 is selected in the current example and illustrated in FIG. 7).

In certain embodiments, after selecting the balloons of the PMI objects a user wants displayed on the intermediate model, the dialogue box 180 may include a second prompt 184 for designating an operation number to the set of PMI objects corresponding to the balloons selected in the first prompt 182. The operation number may be a number associated with the set of balloons selected in the first prompt 182. In some embodiments, a user may identify the intermediate model based on the operation number. For example, an intermediate model with PMI objects associated with balloon 3 may be designated with an operation number 003.

Furthermore, in some instances, a third prompt 186 may be included in the dialogue box 180. The third prompt 186 may allow the user to include a description for the set of PMI objects associated with the selected balloons specified in the first prompt 182. For example, if the balloons associated with hole dimensions for a full model are specified in the first prompt 182, a user may include a description such as “HOLE DIMENSIONS” as the third prompt. In some embodiments, after the third prompt 186 is specified, the third prompt 186 may be associated with the selection made with respect to the first prompt 182 and/or the second prompt 184. In some embodiments, after specifying either of the above mentioned prompts (e.g., first prompt 182, second prompt 184, third prompt 186), a user may select a confirm option 189 to generate an intermediate model that includes the PMI objects associated with the balloons specified in the first prompt 182.

In certain embodiments, the dialogue box 180 may include a fourth prompt 188 for selecting pre-existing operation number options to generate the intermediate model. For example, a user may select the fourth prompt 188 and manually input the operation number or description of the intermediate model associated with the operation number or description. As a further example, a user may scroll through pre-set options of the fourth prompt 188 and select the intermediate model. In some instances, a user may select the confirm option 189 before the intermediate model may be generated.

FIG. 8 is an embodiment of an intermediate model 83 generated from the full model 82 of FIG. 6. In some instances, generating the intermediate model 83 may be based on the selections made on the dialogue box 180. More specifically, the illustrated intermediate model 82 is displayed as a digital product definition (e.g., 2D drawing) that includes a side view of the tube 161 and one PMI object associated with balloon 3, which, as mentioned above, was selected in the dialogue box 180 of FIG. 7. The illustrated PMI object associated with the balloon 3 includes dimension 162 and tolerance 164. Despite the full model 82 of FIG. 6 including six PMI objects (e.g., indicated by the six numbers enclosed in corresponding balloons), the intermediate model 83 includes only the PMI selected in the dialogue box 180 of FIG. 7, enabling the customized models for various teams.

As such, in some embodiments, the intermediate model 83 may include only a subset of the data (e.g., indicative of PMI) included in the full model 82. Any number of PMI objects may be selected for incorporation into the intermediate model 83. For example, in the illustrated embodiment, the intermediate model 83 includes one of the six PMI objects (e.g., the PMI object associated with balloon 3) of the full model. In some instances, the other PMI objects (e.g., the other five PMI objects) may be omitted from the intermediate model 83 because the user may have specified on the dialogue box 180 of FIG. 7 that the intermediate model 83 should only include the PMI object associated with balloon 3.

The intermediate model 83 may be provided to a relevant team. In certain embodiments, modifying the intermediate model 83 (e.g., by the relevant team) may cause the full model 82 from which the data included in the intermediate model 83 was taken from to also update. Furthermore, in some instances, modifying certain PMI (e.g., and/or any other features) of a first intermediate model 84 may cause other intermediate models 83 that share the certain PMI to update to reflect the modification of the certain PMI.

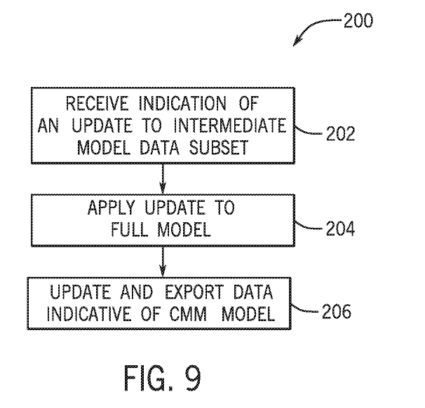

To facilitate such functionality, the intermediate models(s) 83 may utilize common and/or corresponding PMI object identifiers, enabling changes to a PMI object in the intermediate model 83 to be attributed to the full model 82. In more detail, FIG. 9 is a flow diagram illustrating a process 200 whereby the full model of FIG. 6 is updated based on the updates made to the intermediate model of FIG. 8, in accordance with an aspect of the present disclosure.

More specifically, the processor implementing logic 90 may receive an indication of an update to an intermediate model data subset (process block 202). That is, in some embodiments, a user may modify (e.g., update) the PMI objects and/or other features displayed on the intermediate model 83. The processor implementing logic 90 may receive a signal indicative of the modification (e.g., update) to the intermediate model 83. For example, the modifications may include changing the dimension 162 and/or tolerance 164 corresponding to the PMI displayed on the intermediate model 83 of FIG. 8. The processor implementing logic 90 may receive a signal indicative of a change the PMI (e.g., to the dimensions 162 and/or tolerances 164) on the intermediate model 83 and accordingly update the intermediate model 83 to include the modifications. In certain embodiments, the modifications may be any changes to the PMI and/or other features corresponding to the intermediate model 83. In some embodiments, the change indication may include a PMI identifier (e.g., a unique identifier specifying the proper PMI to alter) of the PMI and a change value for the PMI (e.g., a new dimension value).

After receiving an indication to update an intermediate model data subset, the modifications are applied to the full model 82 (process block 204). That is, in some embodiments, the processor implementing logic 90 may update the full model 82 to reflect the modifications made to the intermediate model 83, based on the indication of an update to a data subset of the intermediate model 83. For example, in some embodiments, a plant operator may modify the PMI object of an intermediate model 83. The processor implementing logic 90 may receiving an indication of the update to the intermediate model 83, identify a PMI identifier of the full model 82 corresponding to the PMI indicator of the change indication from the intermediate model 83, and apply the update to the same PMI object on the full model 82, as identified based upon the PMI identifiers. In some embodiments, the update may be applied to the full model 82 in real-time or close to real time.

In some embodiments, the update to the full model 82 may be applied automatically by the processor implementing logic 90. That is, once an intermediate model 83 has been updated the update may be applied to the full model 82 (e.g., in or near real-time).

In certain instances, the update to the full model may be triggered manually, after a plant operator confirms of the updates to the full model. For example, an indication of the update to the intermediate model data subset may be received to a plant operator. After the plant operator confirms the update to the intermediate model, in some embodiments, the update may be applied to the full model (process block 204).

In some embodiments, updating PMI included in a first intermediate model 84 may cause the update to be applied to a second intermediate model 86 when the PMI updated in the first intermediate model 84 is included in the second intermediate model. That is, when the first intermediate model 84 and the second intermediate model 86 share PMI information, and the shared PMI is modified in one of the intermediate models (84 or 86), the other intermediate model (86 or 84) may also be updated (e.g., in or near real-time) to reflect the modification to the PMI information shared between them. For example, if both intermediate models include a PMI associated with the dimension (e.g., width) of a digital product definition illustrating a tube 161, and the PMI associated with the dimension of the tube 161 in one of the intermediate models is modified and updated, in some embodiments, the other intermediate model may be updated to reflect the updated PMI associated with the modified dimension.

Furthermore, in some embodiments, an update to PMI (e.g., or other features) associated with an intermediate mode 83 may be applied to other models that share the PMI. That is, other intermediate models 83 and the full model 82, from which the intermediate models 83 include subset data from, may be updated (e.g., when the models share the PMI that is updated).

Furthermore, in some embodiments, after applying the update to the full model, data indicative of a CMM model 92 may be updated and exported (process block 206). The CMM model 92 may cause the PMI associated with a full model 82 to be organized based on inspection order and/or inspection paths. For example, the CMM model 92 may organize PMI, based at least on how the PMI of the CMM model 92 (e.g., displayed on a digital product definition) are inspected (e.g., by teams 64 of plant operators). Furthermore, the CMM model 92 may organize the PMI according to any suitable priority scheme.

In some embodiments, the data indicative of the CMM model 92 may be exported by the processor implementing logic 90 as, for example, code (e.g., instructions stored in memory that may be executed by a processor of a machine) that may be readable by a machine (e.g., computer, tablet, laptop, etc.). In some embodiments, exporting data indicative of the CMM model 92 may include converting the data from NX code to code that may be read by the machine.

Technical effects of the disclosed subject matter include a product quality plan (PQP) that may be used to update full parts based on modifications (e.g., updates) to intermediate parts. The PQP may be associated with a CAD system that may be used to generate 2D and/or 3D models (e.g., of parts for power generation systems) as digital product definition. Furthermore, a full model may be generated. The full model may include one or more PMI associated with a feature of the part. The PMI may include any GD&T information indicative of the part. Based on selections and/or options to a dialogue box of the PQP, intermediate models may be generated, such that the intermediate models include a subset of the data (e.g., PMI objects) of the full model. The intermediate models may be updated, such that updating data associated with an intermediate models may cause other models (e.g., the full model, CMM model, other intermediate models, etc.) that include similar data to also be updated at or near real-time.

This written description uses examples to disclose the claimed subject matter, including the best mode, and also to enable any person skilled in the art to practice the subject matter, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A tangible, non-transitory, computer-readable medium, comprising computer-readable instructions that, when executed by one or more processors of a computer, cause the one or more processors to:
generate a first digital product definition associated with a computer-aided design (CAD) model;
present, via a graphical-user-interface (GUI) on a display, the first digital product definition, wherein the first digital product definition comprises product and manufacturing information (PMI) associated with the CAD model;
generate a second digital product definition based on a selection via the GUI, wherein the second digital product definition comprises a portion of the PMI associated with the CAD model that is indicated by the selection;
receive an indication to modify at least a subset of the portion of the PMI of the second digital product definition;
modify the at least subset of the portion of the PMI of the second digital product definition based on the indication; and
update the PMI of the first digital product definition, based on the modification to the subset of the portion of the PMI.

2. The tangible, non-transitory, and computer-readable medium of claim 1, wherein instructions are configured to cause the one or more processors to generate a third digital product definition, wherein the third product definition comprises a second portion of the PMI associated with the CAD model.

3. The tangible, non-transitory, computer-readable medium of claim 2, wherein the instruction are configured cause the one or more processors to update a second subset of the second portion of the PMI updates the first and second digital product definition based on the modification to the second subset of the second portion of the PMI.

4. The tangible, non-transitory, computer-readable medium of claim 2, wherein the instruction are configured to cause the one or more processors to update the second and third digital product definition, based on the updates for the PMI of the first digital product definition.

5. The tangible, non-transitory, and computer-readable medium of claim 1, wherein the PMI comprises geometric dimensioning and tolerancing (GD&T) information associated with the CAD model.

6. The tangible, non-transitory, and computer-readable medium of claim 1, wherein the portion of PMI associated with the CAD model comprises a first portion of PMI associated with a manufacturing task, a second portion of PMI associated with a feature of the CAD model, a third portion of PMI associated with dimensions for the CAD model, or any combination thereof.

7. The tangible, non-transitory, and computer-readable medium of claim 1, wherein the GUI comprises a dialogue box, wherein the dialogue box is configured to receive a selection indicative of one or more balloons respectively associated with a portion of PMI, wherein the second digital product definition is generated based on the selection indicative of the one or more balloons specified on the dialogue box.

8. The tangible, non-transitory, and computer-readable medium of claim 1, wherein the instructions configured to cause the one or more processors to modify the subset of the portion of the PMI of the second digital product definition comprises changing GD&T information associated with the second digital product definition based on the indication to modify at least the subset of the portion of the PMI of the second digital product definition.

9. The tangible, non-transitory, and computer-readable medium of claim 1, wherein the instructions are configured to cause the one or more processors to:
match an identifier of the second digital product definition with an identifier of the first digital product definition; and
apply the modifications made to the second digital product definition to the first digital product definition.

10. The tangible, non-transitory, and computer-readable medium of claim 1, wherein the instructions configured to cause the one or more processors to update the PMI of the first digital product definition occur in or near real-time.

11. A system comprising:
a processor for implementing a computer-aided technology (CAx) system, the CAx system comprising a graphical-user-interface (GUI) configured to present a computer-aided design (CAD) model, the CAD model comprising at least one part;
memory storing instructions configured to cause the processor to:
present the GUI;
generate a first digital product definition associated with the CAD model;
present, via the GUI on a display, the first digital product definition, wherein the first digital product definition comprises product and manufacturing information (PMI) associated with the CAD model;
generate a second digital product definition based on a selection via the GUI, wherein the second digital product definition comprises a portion of the PMI associated with the CAD model that is indicated by the selection;
receive, via the GUI, an indication to modify at least a subset of the portion of the PMI of the second digital product definition;
modify the at least subset of the portion of the PMI of the second digital product definition based on the indication; and
update the PMI of the first digital product definition, based on the modification to the subset of the portion of the PMI.

12. The system of claim 11, the memory storing instruction are configured to cause the processor to generate a third digital product definition, wherein the third product definition comprises a second portion of the PMI associated with the CAD model.

13. The system of claim 12, wherein the memory storing instruction are configured to cause the processor to update a second subset of the second portion of the PMI updates the first and second digital product definition based on the modification to the second subset of the second portion of the PMI.

14. The system of claim 12, wherein the memory storing instruction are configured to cause the processor to update the second and third digital product definition, based on the updates for the PMI of the first digital product definition.

15. The system of claim 11, wherein the memory storing instructions are configured to cause the processor to:
match an identifier of the second digital product definition with an identifier of the first digital product definition; and
apply the modifications made to the second digital product definition to the first digital product definition.

16. A computer-implemented method, comprising:
generating, via a processor, a first digital product definition associated with a computer-aided design (CAD) model;
presenting, via a graphical-user-interface (GUI) on a display, the first digital product definition, wherein the first digital product definition comprises product and manufacturing information (PMI) associated with the CAD model;
generating, via the processor, a second digital product definition based on a selection via the GUI, wherein the second digital product definition comprises a portion of the PMI associated with the CAD model that is indicated by the selection;
receiving, via the processor, an indication to modify at least a subset of the portion of the PMI of the second digital product definition;
modifying, via the processor, the at least subset of the portion of the PMI of the second digital product definition based on the indication; and
updating, via the processor, the PMI of the first digital product definition, based on the modification to the subset of the portion of the PMI.

17. The computer-implemented method of claim 16, wherein modifying the at least subset of the portion of the PMI of the second digital product definition comprises:
matching, via the processor, an identifier of the second digital product definition with an identifier of the first digital product definition; and
applying, via the processor, the modifications made to the at least subset of the portion of the PMI of the second digital product definition to the corresponding PMI of the first digital product definition.

18. The computer-implemented method of claim 16, wherein modifying the at least subset of the portion of the PMI of the second digital product definition comprises changing GD&T information associated with the second digital product definition based on the indication to modify at least the subset of the portion of the PMI of the second digital product definition.

19. The computer-implemented method of claim 16, wherein the GUI comprises a dialogue box, wherein the dialogue box is configured to receive a selection indicative of one or more balloons respectively associated with a portion of PMI, wherein the second digital product definition is generated based on the selection indicative of the one or more balloons specified on the dialogue box.

20. The computer-implemented method of claim 16, wherein updating the PMI of the first digital product definition occur in or near real-time.
